(19) United States
(12) Patent Application Publication
(10) Pub. No.: US 2004/0142715 A1
(43) Pub. Date: Jul. 22, 2004

(54) Method and apparatus to predictively regulate forward link packet data transmission power in a wireless communications system

(76) Inventor: David Puig Oses, San Diego, CA (US)

Correspondence Address: Qualcomm Incorporated, Patents Department, 5775 Morehouse Drive, San Diego, CA, 92121-1714, US

(21) Appl. No.: 10/346,616

(22) Filed: Jan. 16, 2003

(51) Int. Cl. H04B 7/216; H04B 7/00; H04Q 7/20; H04M 1/00; H04B 1/38

(52) U.S. Cl. 455/522; 455/561; 370/320; 370/342

(57) ABSTRACT

A base station (110) in a wireless communications network (100) predicts (604) future power consumption by voice data and overhead signaling channels, and utilizes (610) remaining base station power for transmission of digital user data. To provide a safety factor, predicted future power consumption is adjusted (606) by a margin that is selectively increased (614) and decreased (612) according to a relation between actual transmission power and one or more reference power levels (612).

### BACKGROUND

1. Field

The present invention generally relates to the operation of base stations in wireless communications networks. More particularly, the invention concerns a base station, and method for its operation, in which the base station predicts future transmit power consumption by a prescribed group of dedicated voice and control channels as well as common signaling channels, control and data channels and overhead signaling channels, and allocates remaining base station power for transmission of subscribers' packet data over a shared packet data channel. To provide a safety factor, the predicted future transmit power consumption is adjusted by a margin that is selectively increased and decreased according to the relation between actual transmission power and one or more prescribed reference power levels.

2. Background

In recent years, there have been a number of developments in the area of code division multiple access (CDMA) telephony. A number of such improvements have been incorporated in a series of CDMA-2000 standards. Under most or all releases of CDMA-2000, base stations transmit certain information on various fixed-power, common channels, such as pilot signals, synchronization (“synch”) signals, paging signals, broadcast signals, common assignment signals and the like. Some common channels, like the forward common power control channel might also be dynamically powered depending on link quality. These channels are called “common” (or “overhead”) signaling channels because they may be shared by numerous subscriber units in the field.

CDMA-2000 base stations also transmit information on various “dedicated” channels, such as multiple voice, control and digital user data channels. The transmission on each of these channels is intended for a specific user, and thus the term “dedicated”. Each dedicated channel is “dynamically powered” in that the base station increases the level of transmit power responsive to a weaker communications link with the mobile station; conversely, the transmit power is reduced when the link is stronger.

Typically, subscribers' packet data is carried on the so-called forward supplemental channels (F-SCHs). The F-SCHs are typically time-sliced to serve different mobile stations. More accurately stated, each F-SCH is typically assigned to a specific mobile station for a certain period of time, after which the F-SCH for that mobile is released and another F-SCH may be assigned to a different mobile using the same resources. At any given time, only the mobile for which the transmission is intended will monitor and decode the F-SCH. Directions regarding the F-SCH assignment and its duration are given to mobile stations via signaling messages before the assignment starts. Under one implementation, the minimum F-SCH assignment duration is 20 ms, but typically the assignment durations are in the order of hundreds of milliseconds.

Yet to be implemented in the field is a new release of CDMA-2000, known as release “C”, also known as “1xEV-DV.” Under this standard, a new forward packet data channel (F-PDCH) allows a new method for the CDMA base stations to transmit subscribers' packet data and the related signaling to the mobile users. The F-PDCH is not “dedicated” for a specific user, but it is rather “shared” as it carries data that is intended for different users. All users assigned to the F-PDCH continuously monitor it to identify possible transmissions intended for them. More accurately, the users monitor the F-PDCH and the associated forward packet data control channel (F-PDCCH). The F-PDCCH carries all the information required for mobile stations to correctly demodulate and decode the data carried on the F-PDCH. The F-PDCCH also identifies the mobile station to which the F-PDCH transmission is intended. Each F-PDCH has an associated F-PDCCH, and they may be collectively referred to as a packet data channel (PDCH). The PDCH carries the data for multiple users in packets that are sent in a time-shared manner. In that sense, the PDCH is time-sliced among different mobile stations similarly to the F-SCH. Incidentally, at 1.25, 2.5 or 5 ms, the time slices of the PDCH are considerably smaller than the time slices of the F-SCH. As another difference from the F-SCH, release-C base stations will not dynamically adjust transmit power of the PDCH according to link quality. Rather, the link quality is used to decide the PDCH data rate transmissions, and the power for the PDCH is limited to any power remaining between the base station's prescribed maximum transmit power and the transmit power consumed by all the other channels, including common signaling and dedicated channels. Thus, the PDCH transmission power is simply the leftover power.

One of the most significant challenges in implementing this version of CDMA-2000 is finding a way to efficiently utilize the PDCH. Clearly, a base station's PDCH transmission would be most reliable if the base station always utilizes all power remaining after accounting for common signaling and dedicated channel transmissions. Nothing more could be done, since the base station would always be transmitting at its maximum power output. However, it is difficult to anticipate the amount of available base station power because of the uncertainty in predicting power consumption by all of the varied dedicated channels, since each channel's power is dynamically changed according to communications link quality.

There are various consequences for transmitting the PDCH at a power level that is too high or low. If too much power is utilized, the base station will exceed its maximum power output level. This situation is herein called a “power overage”. If the base station transmits too often at a power level that is too high, non-linearities in mixers, filters, high power amplifiers, and other components of the base station's RF chain may distort the transmitted signal. Distortions of the transmitted signal may cause out-of-band frequency components, in other words, power emissions in the adjacent frequencies outside the intended frequency band of operation for that base station. This may in turn cause systems operating on adjacent frequencies to receive too much interference for their proper operation, causing delay or even failure in their own communications. On the other hand, if too little power is utilized, the PDCH data transmission may fail to reliably reach the intended mobile unit, possibly resulting in undesirably slow data rates or even dropped calls.

Accordingly, progress remains to be made in the practical implementation of CDMA-2000 release C architecture, and particularly in the area of efficiently transmitting on the PDCH so as to utilize that power left over after accounting for all other channels, including overhead signaling and dedicated channels.

### SUMMARY

A base station in a wireless communications network predicts future transmit power consumption by a prescribed group of dedicated voice and control channels as well as common signaling channels, and utilizes remaining base station power to transmit on a shared packet data channel. To provide a safety factor, the predicted future transmit power consumption is adjusted by a margin that is selectively increased and decreased according to a relation between actual transmission power and one or more prescribed reference power levels.

### BRIEF DESCRIPTION OF THE DRAWINGS

FIG. 1 is a block diagram of some hardware components and interconnections in a wireless communications network.

FIG. 2 is a block diagram of an exemplary digital data processing machine.

FIG. 3 is a plan view of an exemplary signal-bearing medium.

FIG. 4 is a diagram showing transmit power versus time for common signaling channels, dedicated voice and control channels, and packet data channels.

FIG. 5 is a flowchart illustrating operation of a base station to select and adjust base station power for transmission of digital user data over a shared packet data channel.

### DETAILED DESCRIPTION

The nature, objectives, and advantages of the invention will become more apparent to those skilled in the art after considering the following detailed description in connection with the accompanying drawings.

### Hardware Components & Interconnections

Wireless Communications System

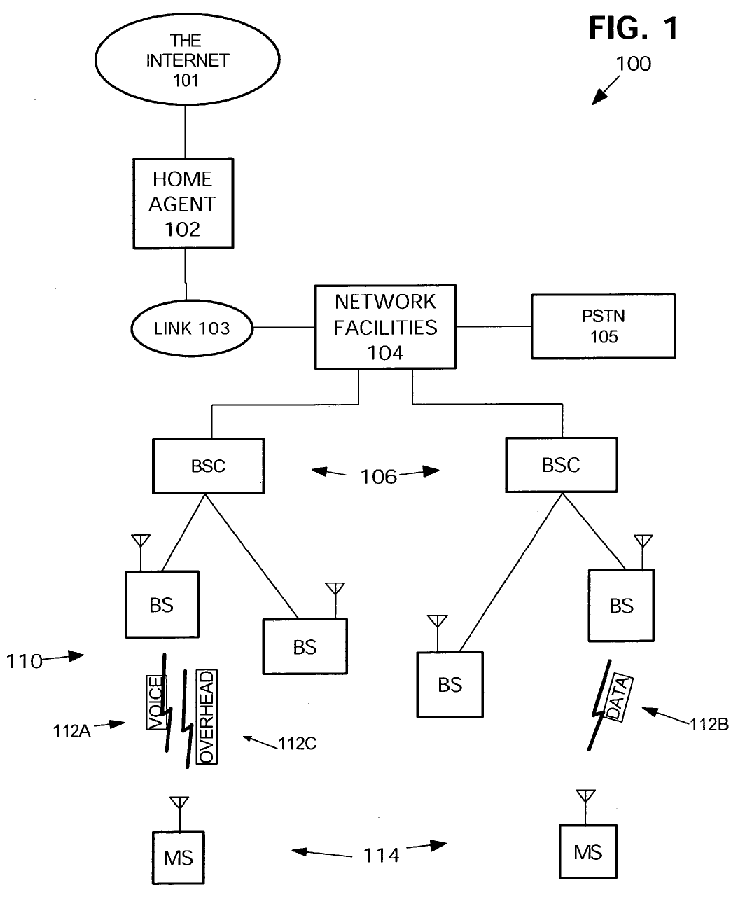

The present disclosure utilizes a wireless communications network with various base stations and mobile stations, among other components. FIG. 1 illustrates a highly simplified model of an exemplary wireless communications network 100. In one embodiment, the network 100 may be implemented as a wireless cellular telephone system according to Telecommunications Industry Association standard IS-95. The IS-95 standard utilizes code division multiple access (CDMA) modulation techniques to wirelessly conduct voice calls with greater capacity and more robust performance than earlier wireless telecommunications technologies. More particularly, the network as discussed herein comprises a CDMA-2000 (release C) system.

The network 100 includes various mobile stations 114, which comprise CDMA compatible wireless telephones (also known by other names such as access terminals, subscriber stations, etc.). Mobile stations 114 are served by various base stations 110, which exchange voice and/or packet data content with the mobile stations 114. In the wireless voice telephone context, telephone calls and other voice communications are conducted by exchanging data between mobile stations 114 and base stations 110 via radio frequency (RF) electromagnetic signal channels such as 112a. Base stations also exchange other overhead signaling with the mobile stations 114, such as call paging messages, origination messages, registration messages, pilot signal reports, and other digital data. The overhead signaling is conducted via RF electromagnetic channels such as 112. Subscribers' packet data is relayed by exchanging internet protocol (IP) packet data between mobile stations 114 and base stations 110 for relay to the Internet 101 or some other packet data network (not shown) such as a corporate network. Examples of packet data include IP datagrams used for such applications as accessing web pages and retrieving e-mail. Such packet data applications may run directly on the mobile stations 114, or may run on a separate computer device that uses the mobile station 114 as a wireless modem. The subscribers' packet data is conducted between mobile stations 114 and base stations 110 via RF electromagnetic signal channels such as digital user data 112b. Although shown with separate mobiles, for ease of illustration, a single mobile may exchange both voice data and digitial user data with base stations.

Some or all of the base stations 110 may be implemented using hardware such as that used by conventional base stations in commercial use today. Each base station 110 is coupled to a base station controller (BSC) 106, which conducts two-way information flow between base stations 110 and various network facilities 104 (described below). The BSCs 106 perform various functions that allow mobile communication to take place, including orchestrating the handoff of mobile stations 114 between base stations. The BSCs also include packet control function (PCF) modules to assist in exchanging IP data packets with the base stations 110. Each BSC 106 may be implemented using hardware such as that used by conventional wireless networks in commercial use today, for example.

As mentioned above, the BSCs 106 conduct communications between the base stations 110 and the network facilities 104. For use in processing voice calls and other IS-95 data, the network facilities 104 may include components such as a mobile switching center (MSC), mobile telephone switching office (MTSO), etc. A MSC component, for example, relays voice stream information between the BSCs 106 and the public switched telephone network (PSTN) 105. An MSC also provides mobility control, call processing, and call routing functionality. As an example, a data services interworking function (IWF) may be used to connect the network facilities 104 to the PSTN 105.

For use in users' packet data, and particularly in the context of providing mobile-IP services, the network facilities 104 may include components such as one or more foreign agents. In this context, the network facilities 104 exchange IP data between the BSCs 106 and one or more home agents 102 via one or more links 103, such as wireless or wire-line T1 or T3 links, fiber optic connections, Ethernet, or other Internet Protocol (IP) connections. The home agent 102, in turn, is operably coupled to the Internet 101.

Exemplary Digital Data Processing Apparatus

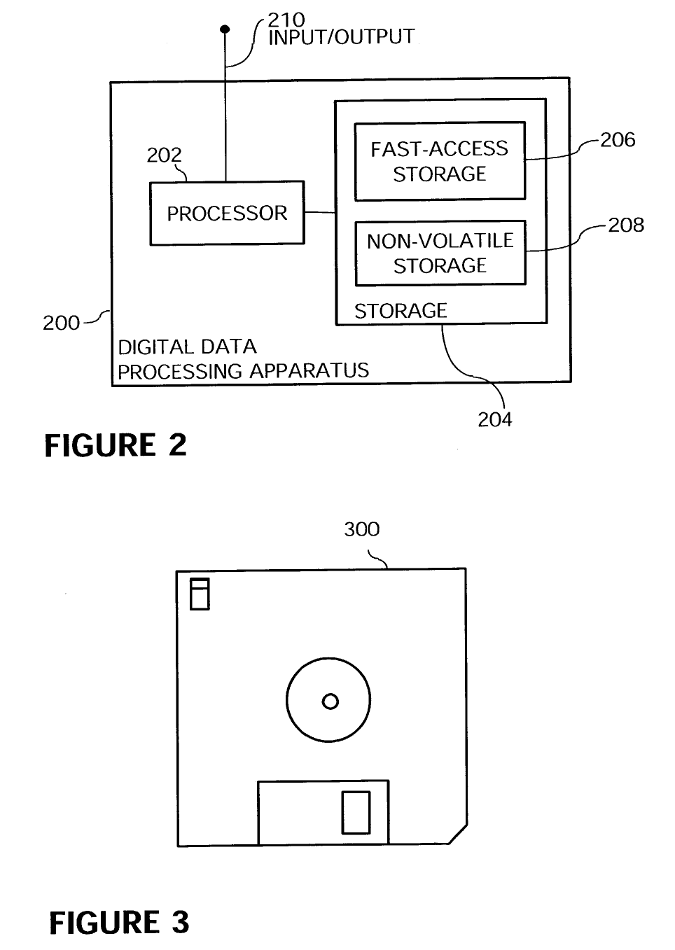

Data processing entities such as components 102, 104, 106, 110, 114 (FIG. 1), or any one or more of their subcomponents may be implemented in various forms. One example is a digital data processing apparatus, as exemplified by the hardware components and interconnections of the digital data processing apparatus 200 of FIG. 2.

The apparatus 200 includes a processor 202, such as a microprocessor, personal computer, workstation, controller, microcontroller, state machine, or other processing machine, coupled to a storage 204. In the present example, the storage 204 includes a fast-access storage 206, as well as nonvolatile storage 208. The fast-access storage 206 may comprise random access memory (“RAM”), and may be used to store the programming instructions executed by the processor 202. The nonvolatile storage 208 may comprise, for example, battery backup RAM, EEPROM, flash PROM, one or more magnetic data storage disks such as a “hard drive”, a tape drive, or any other suitable storage device. The apparatus 200 also includes an input/output 210, such as a line, bus, cable, electromagnetic link, or other means for the processor 202 to exchange data with other hardware external to the apparatus 200.

Despite the specific foregoing description, ordinarily skilled artisans (having the benefit of this disclosure) will recognize that the apparatus discussed above may be implemented in a machine of different construction, without departing from the scope of the invention. As a specific example, one of the components 206, 208 may be eliminated; furthermore, the storage 204, 206, and/or 208 may be provided on-board the processor 202, or even provided externally to the apparatus 200.

Logic Circuitry

In contrast to the digital data processing apparatus discussed above, a different embodiment of the invention uses logic circuitry instead of computer-executed instructions to implement various processing entities such as those mentioned above. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

### Operation

Having described various structural features, some operational aspects of the present disclosure are now described. As mentioned above, one operational aspect of the present disclosure involves base stations predicting future transmit power consumption by a prescribed group of dedicated voice and control channels and common signaling channels, and utilizing remaining base station power to transmit digital user data over a shared packet data channel. Predicted future transmit power consumption is adjusted by a margin that is selectively increased and decreased according to the relation between transmission power and one or more prescribed reference power levels.

Signal-Bearing Media

Wherever any functionality of the present disclosure is implemented using one or more machine-executed program sequences, such sequences may be embodied in various forms of signal-bearing media. In the context of FIG. 2, such a signal-bearing media may comprise, for example, the storage 204 or another signal-bearing media, such as a magnetic data storage diskette 300 (FIG. 3), directly or indirectly accessible by a processor 202. Whether contained in the storage 206, diskette 300, or elsewhere, the instructions may be stored on a variety of machine-readable data storage media. Some examples include direct access storage (e.g., a conventional “hard drive”, redundant array of inexpensive disks (“RAID”), or another direct access storage device (“DASD”)), serial-access storage such as magnetic or optical tape, electronic non-volatile memory (e.g., ROM, EPROM, flash PROM, or EEPROM), battery backup RAM, optical storage (e.g., CD-ROM, WORM, DVD, digital optical tape), paper “punch” cards, or other suitable signal-bearing media including analog or digital transmission media and analog and communication links and wireless communications. In an illustrative embodiment of the invention, the machine-readable instructions may comprise software object code, compiled from a language such as assembly language, C, etc.

Logic Circuitry

In contrast to the signal-bearing medium discussed above, some or all of the present disclosure's functionality may be implemented using logic circuitry, instead of using a processor to execute instructions. Such logic circuitry is therefore configured to perform operations to carry out the method aspect of the invention. The logic circuitry may be implemented using many different types of circuitry, as discussed above.

Operational Details

Introduction

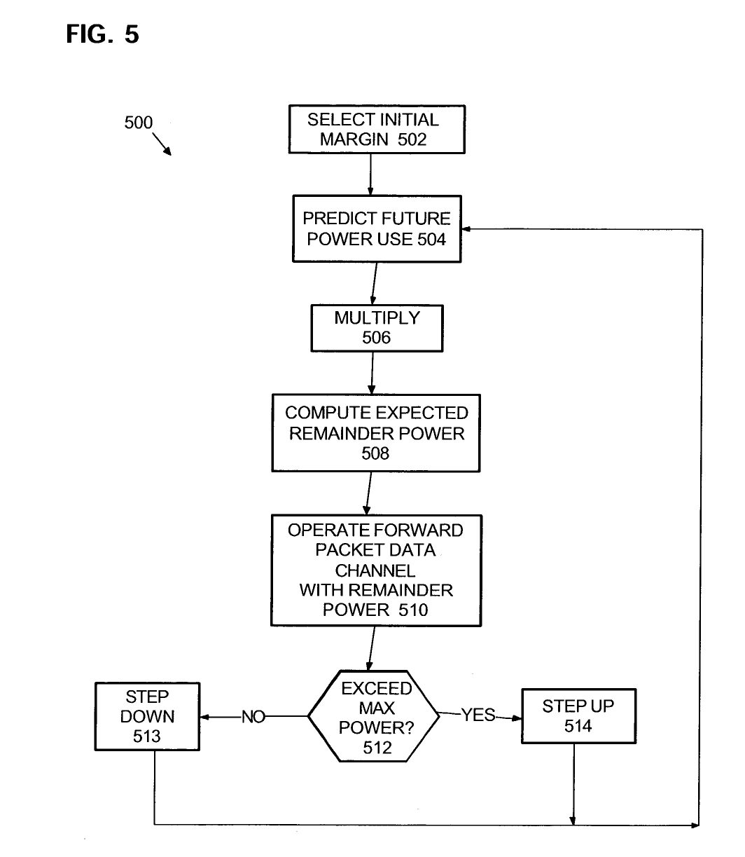

FIG. 5 depicts a sequence for operating a base station under one embodiment of the present disclosure. More particularly, the steps 500 illustrate the operation of a base station to predict future transmit power consumption by a prescribed group of dedicated voice and control channels and common signaling channels, and utilize the remaining base station power to transmit a shared packet data channel. Without any intended limitation, the sequence 500 is explained in the context of the hardware components of FIGS. 1-3.

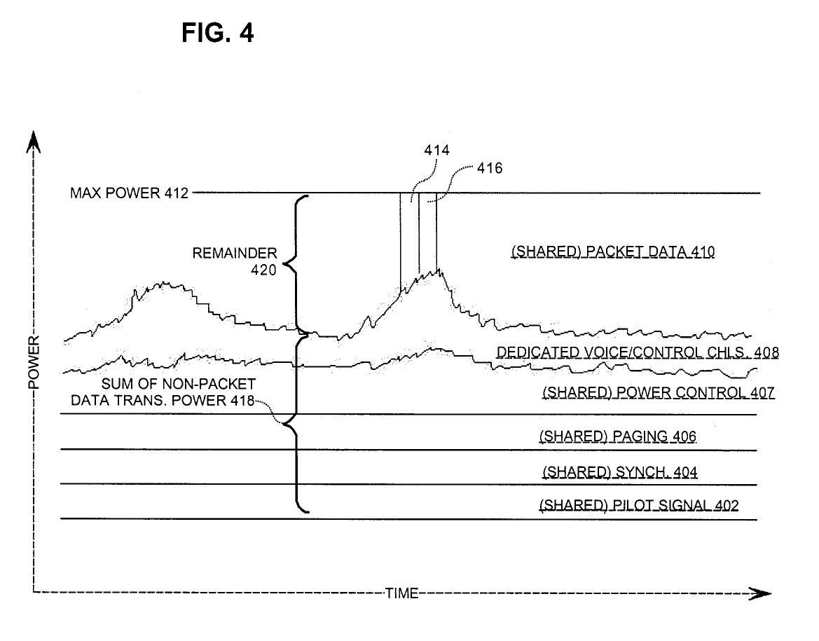

To further aid in describing the operations 500, FIG. 4 illustrates a diagram 400 of a base station's transmit power over time. The base station transmits various common channels such as the pilot 402, synchronization 404, and paging 406 channels with power levels that do not change over time. The base station transmits some different common channels (such as the forward common power control channel 407) with power levels that do change over time in order to preserve communications link quality. The common channels 402, 404, 406-408 may also be referred to as “overhead” signaling channels.

The base station also transmits information to mobile stations on various, separate, dedicated channels (shown collectively as 408) utilizing power levels that change over time, in order to preserve communications link quality. These channels are intended for a specific user and thus may be referred to as “dedicated” channels. In the illustrated example, the channels 408 represent voice channels assigned to individual subscribers.

The shared packet data channel 410 utilizes “remainder” 420 transmit power, that is, the difference between a given maximum transmit power 412 and the sum 418 of the transmissions 402-408. The sum 418 is the sum of the base station's transmissions on dedicated voice channels 408 and common signaling channels 402-407.

With support of FIG. 4 as introduced above, the operations 500 are now described in greater detail with additional reference to FIG. 5.

Select Initial Margin

In step 502, the base station chooses an initial value for a “margin”, the meaning and use of which are described below. Alternatively, the margin may be set by a technician, program, or other entity, such as during the installation, boot-up, configuration, reconfiguration, or other modification of the subject base station. The margin may comprise a multiplier, additive factor, percentage, logarithmic enhancement, or other linear or nonlinear modifier. In the present example, the margin comprises a number (multiplicative factor), which modifies the sum 418 of the voice and overhead signaling power when multiplied by this margin. When greater than one, the margin inflates the sum 418; when less than one, the margin reduces the sum 418, as explained below. Under most circumstances, the margin is expected to be greater than one, so that it always inflates the sum 418, and thereby under-estimates the remaining transmit power 420 in order to avoid over-transmitting. Use and adjustment of the margin are discussed in greater detail below.

To start out with, the margin may be initially set 502 to a value of one. As described below, the margin is iteratively increased and/or decreased to suit the requirements of the base station.

Predict Future Power Use

In step 504, the base station predicts the future transmit power consumption by a prescribed group of channels. In the illustrated example, these channels include the base station's common signaling channels and dedicated voice channels, or in other words, all non-packet data channels. More particularly, the prescribed group of channels includes the overhead signaling channels 402-406, control channel 407, and voice channels 408. In other words, step 504 predicts the portion of future transmit power represented by the sum 418. Alternatively stated, step 504 predicts the base station's future transmit power for all transmissions except those that are to be variable power packet data messages.

As a more particular example, the prescribed group of channels includes the forward common assignment channels, forward common power control channels, forward pilot channels, forward common control channels, forward sync channel, forward broadcast control channels, forward paging channels, forward quick paging channels, forward dedicated control channels, forward fundamental channels, forward power control subchannel, forward supplemental code channels and forward supplemental channels. Alternatively, the prescribed channels may be defined as including all transmission (“forward”) channels of the base station, except for the power-adjusted packet data channels, namely, the forward packet data channel (F-PDCH) and forward packet data control channel (F-PDCCH).

As one example, the base station may predefine time slices, windows, or other time periods, or use already-predefined divisions, to distinguish different intervals of time in reference to the channels 402-410. One example of such a time division is the power control group (PCG) utilized by the CDMA-2000 standard. To provide two examples of time windows, FIG. 4 illustrates adjacent time windows 414, 416.

Utilizing time windows as discussed, and utilizing the illustrated example where the prescribed channel group includes the channels 402-407, step 504 involves an operation, conducted before arrival of a given time window 416, of predicting future power consumption by the channels 402-407 during the window 416.

The transmit power 418 may be predicted using various techniques or combinations of techniques. For example, the transmit power for future window 416 may be predicted by analyzing the magnitude, slope, and/or other historical characteristics of the waveform exhibited by the power sum 418. For instance, future transmit power may be predicted by utilizing a weighted average of historical transmit power. As a more detailed example, Equation 1 (below) shows a linear combination of available past measures of aggregate power.

$${P}_{predicted} [ n ] = {\sum }_{i = 0}^{N - 1} {a}_{i} * {P}_{common + dedicated} [ n - k - i ] \qquad Equation 1$$

where:

n identifies the particular time window for which power utilization is being predicted; identification is according to an arbitrary numeral sequence attributed to the time windows

P_{predicted}[n] is the predicted aggregate transmit power 418 for the future time window n.

P_{common+dedicated}[n−k−i] is the past measured aggregate transmit power 418 for the past time window n−k−i.

aᵢ is a weight applied to the past measured aggregate transmit power 418 for the past time window n−k−i.

N is the total number of past time windows' measured aggregate transmit power 418 considered (where N can be between zero an infinity).

k refers to the prediction delay in units of time windows (where k must be at least one).

As an example, the transmit power can be predicted one time window in advance by extrapolating the power changes in the latest two time windows, as shown by Equation 2, below:

P_{predicted}[n]=2*P_{common+dedicated}[n−1]P_{common+dedicated}[n−2] Equation 2

Alternatively, future transmit power may be predicted by adding the latest power measurement available for the channels 402-407, adjusted according to any rate changes or discontinued transmission scheduled to occur between the time at which the measurement was taken and the time for which the prediction is to be applied. Information on rate changes or discontinued transmissions may be obtained from a source such as a BSC, scheduler facility, or other appropriate network component. Equation 3 (below) shows an example of such prediction:

$${P}_{predicted} [ n ] = {\sum }_{i ∈ common + \\ dedicated \\ channels} {P}_{i} [ n - k ] * Adjustment ( rate [ n - k ] , rate [ n ] ) \qquad Equation 3$$

where:

n identifies the particular time window for which power utilization is being predicted; identification is according to an arbitrary numeral sequence attributed to the time windows

P_{predicted}[n] is the predicted aggregate transmit power 418 for the future time window n.

Pᵢ[n−k] is the measured power consumed by the channel i at past time window n−k.

k is the delay in time windows between the time when the power measurement was taken and the time when the prediction is to be applied (where k is at least one)

Adjustment(rate[n−k],rate[n]) is the known relative power variation for the channel i based on the rates used on that channel at time window (n−k) and time window n.

Multiply By Margin, Compute Expected Remainder Power

In step 506, the base station conditions the predicted power from step 504 according to the margin from step 502. In the illustrated example, the predicted power is multiplied by the margin. The product is a predicted power consumption that has been adjusted by the margin to avoid exceeding the max power level 412 as discussed below.

In step 508, the base station computes remaining base station transmit power by subtracting the adjusted predicted future power from the prescribed maximum transmit power 412. In other words, the remainder power is the difference between the base station's max power 412 and the adjusted, predicted power from step 506.

As discussed below, the margin is adjusted empirically. Namely, the margin is adjusted according to the relation between the base station's actual transmission power and one or more prescribed reference power levels (such as the base station's max power). Therefore, in some cases, the margin may cause the predicted power to increase, in which case there is assumed to be less remainder power, and this decreases the likelihood of exceeding the max power level 412. In other cases, the margin may still cause the predicted power to increase, but not so much. In still other cases, the margin may cause the predicted power to decrease, in case the remaining power has been underestimated. The adjustment of the margin for these purposes is discussed in greater detail below.

Operate at Expected Remainder Power

In step 510, at the given time window 416 for which the prediction of step 504 was made, the base station transmits user's packet data 410 utilizing the remaining base station transmit power computed in step 508. Without diverging from the present disclosure, the base station may operate at slightly more, slightly less, or another desired fixed or variable offset from the computed remaining base station power.

Adjust Margin

Next, the base station adjusts the margin according to the relation between the base station's actual transmit power and one or more prescribed reference levels. In the specific example of steps 512-514, the margin is adjusted according to whether the base station exceeds the prescribed maximum transmit power or not during the given time window 416. More specifically, in the illustrated example, the base station determines whether the transmission during time window 416 exceeded the max power 412 (step 512). If so, this is called a “power overage,” and the base station increases the margin (step 514). If not, the base station reduces the margin (step 513).

More broadly stated, step 512 may be designed to answer based on whether the transmit power of the base station satisfies a predetermined criteria with respect to one or more reference levels (such as the maximum transmit power) during the given time window. For instance, step 512 may be conducted to answer “yes” if the transmit power exceeds the max power by a certain absolute amount or percentage, or if the transmit power merely reaches the max power, or if the transmit power almost reaches the max power falling short by a specified absolute amount or percentage of the max power, etc. Thus, the reference level(s) may be set at the max power or another advantageous level. Step 512 is therefore not limited to a single comparison, and ordinarily skilled artisans (having the benefit of this disclosure) will recognize a variety of other satisfactory approaches to carry out step 512 as contemplated by this disclosure.

As one exemplary technique to implement steps 513, 514, the base station may multiply the margin by a prescribed factor (such as 1.25) in step 514, and multiply the margin by a different prescribed factor (such as 0.97) in step 513. In this way, the margin is rapidly increased to prevent over transmitting, but gradually reduced to prevent under-utilization of the remainder power 420. The ratio between the prescribed factors of steps 513, 514 can be set to achieve the desired rate of power overages.

In contrast to this multiplicative approach, the margin may be adjusted additively, in which case the conditioned predicted power (506) is also computed additively. In this case, the margin and the predicted future power use comprise an amount of power in decibels. The conditioned predicted power is computed 506 not by multiplying the predicted future power use 504 by the margin, but by adding the margin to the predicted future power use. Whenever the margin is adjusted in steps 512-514, then, it is adjusted additively by an amount of decibels. In step 514, the margin is increased by adding a prescribed amount of decibels, referred to as up-step. In step 513, the margin is decreased by adding a prescribed amount of decibels, referred to as down-step. Again, the ratio between the up-step and the down-step can be set to achieve a desired rate of power overages, as shown in Equation 4, below.

$$down \text{-} step = \frac{up \text{-} step}{\frac{1}{Power overages rate} - 1} \qquad Equation 4$$

where:

down-step is the amount by which the margin is decremented each time in 513, in decibels.

up-step is the amount by which the margin is incremented each time in step 514, in decibels.

Power overages rate is the target rate for the base station exceeding the prescribed maximum power 412.

As a further example, steps 512-514 may utilize adaptations of the teachings disclosed in FIGS. 2A-3B of U.S. Pat. No. 5,960,361 (assigned to QUALCOMM INCORPORATED), even though the use of such techniques disclosed in the '361 patent differs from the subject application. The entirety of the foregoing reference is incorporated by reference. Further detail of other such approaches for iterative adjustment are shown by other QUALCOMM references such as U.S. Pat. Nos. 5,056,109 and 5,396,516, and U.S. patent application Ser. No. 09/340,499 filed on Jun. 30, 1999 and published Jan. 4, 2001 under the Patent Cooperation Treaty as publication number WO 01/01603 A1. Each of the foregoing references in its entirety is incorporated herein by reference.

After steps 513, 514, the routine 500 returns to step 504 to make predictions for the next time window. Thus, the steps 504-514 are performed repeatedly. The sequence 500 may end, however, whenever the base station is taken offline or the routine 500 is otherwise disabled.

### Other Embodiments

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

Moreover, the previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The word “exemplary” is used herein to mean “serving as an example, instance, or illustration.” Any embodiment described herein as “exemplary” is not necessarily to be construed as preferred or advantageous over other embodiments.

What is claimed is:

1. A method for operating a base station in a wireless communications system, comprising operations of:
before arrival of a given time window, predicting future power consumption by the base station during the given time window for transmission of a prescribed group of channels;
conditioning the predicted future power by a margin;
computing remaining base station transmit power by subtracting the conditioned predicted future power from a prescribed maximum transmit power;
at the given time window, transmitting users' packet data at an actual a transmit power level substantially equal to the computed remaining base station transmit power;
adjusting the margin according to a relation between the actual transmit power of the base station and at least one prescribed reference power level during the given time window.

2. The method of claim 1, the prescribed group of channels comprising:
all overhead signaling channels and all dedicated voice channels.

3. The method of claim 1, the prescribed group of channels comprising:
all transmit channels of the base station except any variable power forward link packet data channels.

4. The method of claim 1, the prescribed group of channels comprising:
forward common assignment channels, forward common power control channels, forward pilot channels, forward common control channels, forward sync channel, forward broadcast control channels, forward paging channels, forward quick paging channels, forward dedicated control channels, forward fundamental channels, forward power control subchannels, forward supplemental code channels, and forward supplemental channels.

5. The method of claim 1, the operations further comprising:
repeatedly performing the predicting, conditioning, computing, transmitting, and adjusting operations.

6. The method of claim 1, the predicting operation comprising at least one of the following:
measuring power consumed by the prescribed group of channels, consulting a source to identify any transmission rate changes scheduled to occur between the measuring and the given time window, and adjusting the measured power by the identified changes;
analyzing characteristics of transmission power history of the base station.

7. The method of claim 1, the conditioning operation comprising:
multiplying the predicted future power by the margin.

8. The method of claim 1, the operation of adjusting the margin comprises:
adjusting the margin according to a relation between the actual transmit power and the maximum transmit power.

9. The method of claim 1, the adjusting operation comprising:
if the actual transmit power exceeds the reference power level, increasing the margin by a first prescribed increment;
if the actual transmit power does not exceed the reference power level, decreasing the margin by a second prescribed increment.

10. The method of claim 9, the first increment being substantially larger than the second increment.

11. A method for operating a base station in a wireless communications system, comprising steps of:
a step for before arrival of a given time window, predicting future power consumption by the base station during the given time window for transmission of a prescribed group of channels;
a step for conditioning the predicted future power by a margin;
a step for computing remaining base station transmit power by subtracting the conditioned predicted future power from a prescribed maximum transmit power;
a step for, at the given time window, transmitting users' packet data at an actual a transmit power level substantially equal to the computed remaining base station transmit power;
a step for adjusting the margin according to a relation between the actual transmit power of the base station and at least one prescribed reference power level during the given time window.

12. A signal bearing medium tangibly embodying a program of machine-readable instructions executable by a digital data processor to perform operations to operate a base station in a wireless communications system, the operations comprising:
before arrival of a given time window, predicting future power consumption by the base station during the given time window for transmission of a prescribed group of channels;
conditioning the predicted future power by a margin;
computing remaining base station transmit power by subtracting the conditioned predicted future power from a prescribed maximum transmit power;
at the given time window, transmitting users' packet data at an actual a transmit power level substantially equal to the computed remaining base station transmit power;
adjusting the margin according to a relation between the actual transmit power of the base station and at least one prescribed reference power level during the given time window.

13. The medium of claim 12, the prescribed group of channels comprising:
all overhead signaling channels and all dedicated voice channels.

14. The medium of claim 12, the prescribed group of channels comprising:
all transmit channels of the base station except any variable power forward link packet data channels.

15. The medium of claim 12, the prescribed group of channels comprising:
forward common assignment channels, forward common power control channels, forward pilot channels, forward common control channels, forward sync channel, forward broadcast control channels, forward paging channels, forward quick paging channels, forward dedicated control channels, forward fundamental channels, forward power control subchannels, forward supplemental code channels, and forward supplemental channels.

16. The medium of claim 12, the operations further comprising:
repeatedly performing the predicting, conditioning, computing, transmitting, and adjusting operations.

17. The medium of claim 12, the predicting operation comprising at least one of the following:
measuring power consumed by the prescribed group of channels, consulting a source to identify any transmission rate changes scheduled to occur between the measuring and the given time window, and adjusting the measured power by the identified changes;
analyzing characteristics of transmission power history of the base station.

18. The medium of claim 12, the conditioning operation comprising:
multiplying the predicted future power by the margin.

19. The medium of claim 12, the operation of adjusting the margin comprises:
adjusting the margin according to a relation between the actual transmit power and the maximum transmit power.

20. The medium of claim 12, the adjusting operation comprising:
if the actual transmit power exceeds the reference power level, increasing the margin by a first prescribed increment;
if the actual transmit power does not exceed the reference power level, decreasing the margin by a second prescribed increment.

21. The medium of claim 20, the first increment being substantially larger than the second increment.

22. Circuitry including multiple interconnected electrically conductive elements configured to perform operations to perform operations to operate a base station in a wireless communications system, the operations comprising:
before arrival of a given time window, predicting future power consumption by the base station during the given time window for transmission of a prescribed group of channels;
conditioning the predicted future power by a margin;
computing remaining base station transmit power by subtracting the conditioned predicted future power from a prescribed maximum transmit power;
at the given time window, transmitting users' packet data at an actual a transmit power level substantially equal to the computed remaining base station transmit power;
adjusting the margin according to a relation between the actual transmit power of the base station and at least one prescribed reference power level during the given time window.

23. A base station apparatus, comprising:
a transceiver;
at least one antenna coupled to the transceiver;
a digital data processor programmed to perform operations comprising:
before arrival of a given time window, predicting future power consumption by the base station during the given time window for transmission of a prescribed group of channels;
conditioning the predicted future power by a margin;
computing remaining base station transmit power by subtracting the conditioned predicted future power from a prescribed maximum transmit power;
at the given time window, transmitting users' packet data at an actual a transmit power level substantially equal to the computed remaining base station transmit power;
adjusting the margin according to a relation between the actual transmit power of the base station and at least one prescribed reference power level during the given time window.

24. A base station apparatus, comprising:
means for transceiving;
antenna means for interfacing between the means for transceiving and an air medium;
digital data processing means for performing operations comprising:
before arrival of a given time window, predicting future power consumption by the base station during the given time window for transmission of a prescribed group of channels;
conditioning the predicted future power by a margin;
computing remaining base station transmit power by subtracting the conditioned predicted future power from a prescribed maximum transmit power;
at the given time window, transmitting users' packet data at an actual a transmit power level substantially equal to the computed remaining base station transmit power;
adjusting the margin according to a relation between the actual transmit power of the base station and at least one prescribed reference power level during the given time window.

25. A method of operating a base station in a wireless communications network, comprising operations of:
predicting future power levels required to transmit a prescribed group of channels;
adjusting the predicted future power levels by a margin that is selectively increased and decreased according to a relation between actual transmission power of the base station and at least one prescribed reference power level;
transmitting subscriber's packet data at a preestablished maximum transmit power reduced by the adjusted predicted future power levels.

26. The method of claim 25, the prescribed group of channels comprising:
all overhead signaling channels and all dedicated voice channels.

27. The method of claim 25, the prescribed group of channels comprising:
all transmit channels of the base station except any variable power forward link packet data channels.

28. The method of claim 25, the prescribed group of channels comprising:
forward common assignment channels, forward common power control channels, forward pilot channels, forward common control channels, forward sync channel, forward broadcast control channels, forward paging channels, forward quick paging channels, forward dedicated control channels, forward fundamental channels, forward power control subchannels, forward supplemental code channels, and forward supplemental channels.

29. The method of claim 25, the operations further comprising:
repeatedly performing the predicting, adjusting, and transmitting operations for different time periods.

30. The method of claim 25, the predicting operation comprising at least one of the following:
measuring power consumed by the prescribed group of channels, consulting a source to identify any transmission rate changes scheduled to occur between the measuring and the given time window, and adjusting the measured power by the identified changes;
analyzing characteristics of transmission power history of the base station.

31. The method of claim 25, the adjusting operation comprising:
multiplying the predicted future power by the margin.

32. The method of claim 25, the operations further comprising:
selectively increasing and decreasing the margin according to a relation between actual transmission power of the base station and at least one prescribed reference power level.

33. The method of claim 25, the operations further comprising:
adjusting the margin according to a relation between the actual transmit power and the maximum transmit power.

34. The method of claim 25, the operations further comprising adjusting the margin by performing operations comprising:
if the actual transmit power exceeds the reference power level, increasing the margin by a first prescribed increment;
if the actual transmit power does not exceed the reference power level, decreasing the margin by a second prescribed increment.

35. The method of claim 34, the first increment being substantially larger than the second increment.

36. A method of operating a base station in a wireless communications network, comprising steps of:
a step for predicting future power levels required to transmit a prescribed group of channels;
a step for adjusting the predicted future power levels by a margin that is selectively increased and decreased according to a relation between actual transmission power of the base station and at least one prescribed reference power level;
a step for transmitting subscriber's packet data at a preestablished maximum transmit power reduced by the adjusted predicted future power levels.

37. A signal bearing medium tangibly embodying a program of machine-readable instructions executable by a digital data processor to perform operations to a base station in a wireless communications network, comprising operations of:
predicting future power levels required to transmit a prescribed group of channels;
adjusting the predicted future power levels by a margin that is selectively increased and decreased according to a relation between actual transmission power of the base station and at least one prescribed reference power level;
transmitting subscriber's packet data at a preestablished maximum transmit power reduced by the adjusted predicted future power levels.

38. The medium of claim 37, the prescribed group of channels comprising:
all overhead signaling channels and all dedicated voice channels.

39. The medium of claim 37, the prescribed group of channels comprising:
all transmit channels of the base station except any variable power forward link packet data channels.

40. The medium of claim 37, the prescribed group of channels comprising:
forward common assignment channels, forward common power control channels, forward pilot channels, forward common control channels, forward sync channel, forward broadcast control channels, forward paging channels, forward quick paging channels, forward dedicated control channels, forward fundamental channels, forward power control subchannels, forward supplemental code channels, and forward supplemental channels.

41. The medium of claim 37, the operations further comprising:
repeatedly performing the predicting, adjusting, and transmitting operations for different time periods.

42. The medium of claim 37, the predicting operation comprising at least one of the following:
measuring power consumed by the prescribed group of channels, consulting a source facility to identify any transmission rate changes scheduled to occur between the measuring and the given time window, and adjusting the measured power by the identified changes;
analyzing characteristics of transmission power history of the base station.

43. The medium of claim 37, the adjusting operation comprising:
multiplying the predicted future power by the margin.

44. The medium of claim 37, the operations further comprising:
selectively increasing and decreasing the margin according to a relation between actual transmission power of the base station and at least one prescribed reference power level.

45. The medium of claim 37, the operations further comprising:
adjusting the margin according to a relation between the actual transmit power and the maximum transmit power.

46. The medium of claim 37, the operations further comprising adjusting the margin by performing operations comprising:
if the actual transmit power exceeds the reference power level, increasing the margin by a first prescribed increment;
if the actual transmit power does not exceed the reference power level, decreasing the margin by a second prescribed increment.

47. The medium of claim 46, the first increment being substantially larger than the second increment.

48. Circuitry including multiple interconnected electrically conductive elements configured to perform operations to perform operations to operate a base station in a wireless communications system, the operations comprising:
predicting future power levels required to transmit a prescribed group of channels;
adjusting the predicted future power levels by a margin that is selectively increased and decreased according to a relation between actual transmission power of the base station and at least one prescribed reference power level;
transmitting subscriber's packet data at a preestablished maximum transmit power reduced by the adjusted predicted future power levels.

49. A base station apparatus, comprising:
a transceiver;
at least one antennae coupled to the transceiver;
a digital data processor programmed to perform operations comprising:
predicting future power levels required to transmit a prescribed group of channels;
adjusting the predicted future power levels by a margin that is selectively increased and decreased according to a relation between actual transmission power of the base station and at least one prescribed reference power level;
transmitting subscriber's packet data at a preestablished maximum transmit power reduced by the adjusted predicted future power levels.

50. A base station apparatus, comprising:
means for transceiving;
antenna means for interfacing between the means for transceiving and an air medium;
digital data processing means programmed to perform operations comprising:
predicting future power levels required to transmit a prescribed group of channels;
adjusting the predicted future power levels by a margin that is selectively increased and decreased according to a relation between actual transmission power of the base station and at least one prescribed reference power level;
transmitting subscriber's packet data at a preestablished maximum transmit power reduced by the adjusted predicted future power levels.
